(19) United States
(12) Patent Application Publication
(10) Pub. No.: US 2020/0184735 A1
(43) Pub. Date: Jun. 11, 2020

(54) MOTION TRANSFORMING USER INTERFACE FOR GROUP INTERACTION WITH THREE DIMENSIONAL MODELS

(71) Applicant: Finger Food Studios, Inc., Port Coquitlam (CA)

(72) Inventor: Steven William Pridie, Burnaby (CA)

(21) Appl. No.: 16/710,448

(22) Filed: Dec. 11, 2019

Related U.S. Application Data
(60) Provisional application No. 62/777,891, filed on Dec. 11, 2018.

(51) Int. Cl. G06T 19/20; G06T 19/00; G06F 3/01; G02B 27/01

(52) U.S. Cl. CPC G06T 19/20; G02B 27/017; G06F 3/012; G06T 19/006

(57) ABSTRACT

There is disclosed a system for interacting with a computer-generated three-dimensional model including a head-mounted display for displaying the three-dimensional model, the head-mounted display incorporating at least one sensor for tracking movement of a human head, the head-mounted display in communication with a computing device used in generating the three-dimensional model, the computing device may be used to translate the movement tracked by the at least one sensor into a first set of actions, relative to the three-dimensional model, when in a first mode and, upon an indication by a user, to change to a second mode and translating the movement tracked by the at least one sensor into a second set of actions relative to the three-dimensional model.

### RELATED APPLICATION INFORMATION

This patent claims priority from U.S. provisional patent application No. 62/777,891 filed Dec. 11, 2018 and entitled “Motion Transforming User Interface for Group Interaction with Three Dimensional Models in Augmented Reality.”

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates to user interfaces for computer-generated environments and more particularly, to a dynamically changing user interface and associated interaction systems for use in augmented and virtual reality.

### Description of the Related Art

There has been a steady advance in the type of systems used by computer operators from simple text-only screens, to Windows®-style systems incorporating visual elements and cues, to three-dimensional games and systems, and more recently to increasing mainstream adoption of virtual reality and augmented reality systems and environments. Each of these environments naturally result in certain conventions for use of those environments and for interactivity enabling human interaction and control of those systems.

For example, for early computers, only a keyboard was used to input text commands and the computer would respond. After graphical capabilities advanced, and the “mouse” was invented—initially, primarily for artistic endeavors using the computer—the “windows” convention and overall graphical user interfaces came into vogue. Those interfaces enabled computers to perform multiple functions at once (multi-tasking) and generally made operating within those environments more user-friendly by offering systems like menus (displaying all options available for commands) and visual representations of file systems (e.g. the file and folder structure visualized for a more general user population.

Similarly, as three-dimensional graphics processing units (e.g. GPUs) came into vogue and were widely adopted, still more complex user conventions became available. Initially, computer gaming utilized only the mouse and keyboard, and, for example, oftentimes a player-character's gaze was fixed looking directly outward, rather than in full three-hundred sixty degree motion, enabling the user to only look in a circle about their avatar, and to move about within that world. This convention eventually gave way to “mouse-look” which enabled the mouse to operate as a camera rig, letting the user “look around” at any location within a three-dimensional world that he or she desired. Movement was separated from looking, mostly, enabling a user to simultaneously move to the side, while looking forward, within the world. This movement more naturally emulates real-world movement and, thus, is rather simple to grasp for a given user, despite the somewhat complex mechanical interaction required (e.g. simultaneous mouse and keyboard input in different directions).

Virtual reality (VR) and augmented reality (AR) are yet another opportunity for interaction with a computer or computing device to change to better suit the environment in which the interaction is taking place. Initially, because most of the experiences available in AR and VR are based upon three-dimensional game engines, the interactions have matched those available in video games (e.g. mouse look, movement with a joystick or keyboard, etc.). As blocks of text and commands gave way to windows, which gave way to fully-realized three-dimensional environments, the interactions available to the user changed and morphed depending upon the system in which they were operating; AR and VR offer yet another opportunity for those conventions to change or better adapt to the particulars and capabilities of the new paradigm.

### DESCRIPTION OF THE DRAWINGS

FIG. 1 is an overview of a system for interacting with three-dimensional objects in augmented reality or virtual reality.

FIG. 2 is a functional block diagram of a system for interacting with three-dimensional objects in augmented reality or virtual reality.

FIG. 3 is a computing device.

FIG. 4 is a flowchart of a process for interacting with three-dimensional objects in augmented reality or virtual reality.

FIG. 5 is a flowchart of a process for sharing interaction with three-dimensional objects in augmented reality or virtual reality.

FIG. 6 is an example set of three-dimensional objects.

FIG. 7 shows an interaction with an example set of three-dimensional objects in a first mode.

FIG. 8 shows a different interaction with an example set of three-dimensional objects in a first mode.

FIG. 9 shows still another interaction with an example set of three-dimensional objects in a first mode.

FIG. 10, including FIGS. 10A and 10B, shows an interaction with an example set of three-dimensional objects in a second mode.

FIG. 11 shows a different interaction with an example set of three-dimensional objects in a second mode.

FIG. 12 shows still another interaction with an example set of three-dimensional objects in a second mode.

FIG. 13 shows a user creating a sharable interaction including a user highlight with an example set of three-dimensional objects.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously described element having a reference designator with the same least significant digits.

### DETAILED DESCRIPTION

### Description of Apparatus

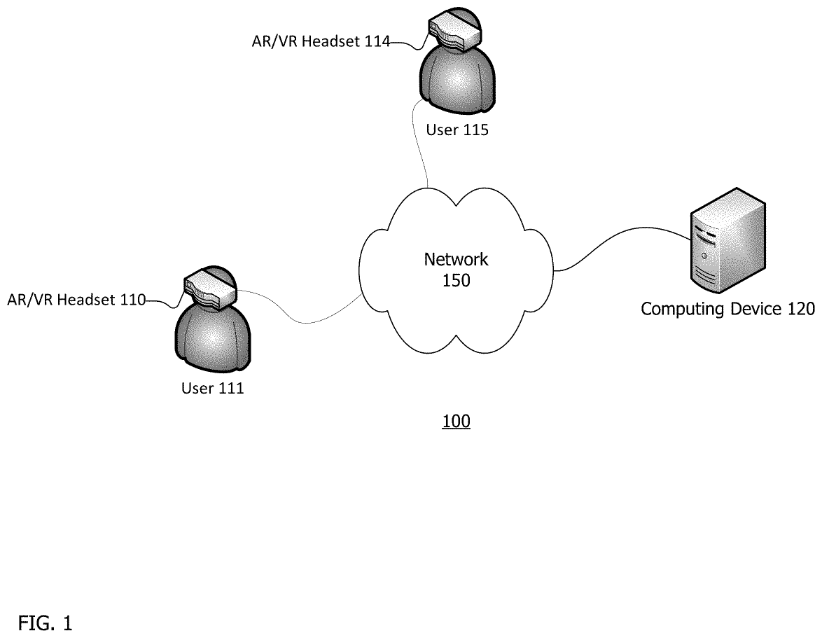

Referring now to FIG. 1, an overview of a system 100 for interacting with three-dimensional objects in augmented reality or virtual reality is shown. The system 100 includes an AR/VR headset 110, used by a user 111, an AR/VR headset 114 used by user 115, and a computing device 120, all interconnected by a network 150.

The AR/VR headset 110 is a head-worn device for viewing augmented reality and/or virtual reality content and for adjusting an image shown by the headset 110 based upon movement of the head of user 111. The AR/VR headset 110 has a built-in display, a mobile device mounted as a display, or one or more projectors for projecting a display onto the environment, a lens, or through a waveguide or similar system to the eyes of a user (e.g. user 111). Although shown as a headset or head-worn, in some cases only a projector or a motion tracker, or an external tracker for tracking a user's head may be used. Regardless, AR/VR headset 110 is head-based, altering the images shown, by whatever system, based upon movement of the head of user 111 so as to “track” the movement and adjust the image accordingly.

The AR/VR headset 110 may include a computer for performing all of the tracking integration and generating the images displayed on the display, or those capabilities may be offloaded to a remote computing device, such as computing device 120, which is more powerful, or otherwise to cloud computing capabilities. Common examples of AR/VR headsets 110 that are popular at present include the Oculus Rift® and/or Oculus® Quest, the Microsoft® Hololens® (now in version two of that product), and mobile-phone based systems like Google® Daydream® or AR/VR capabilities provided by mobile devices that may be integrated into a headset. Though described with reference to a headset, some or all capabilities herein may be available to suitable handheld devices such as mobile phones and tablet computers, with the tracking of the head being replaced with movement of the device itself.

The AR/VR headset 114 is essentially identical to the AR/VR headset 110, but is shown to indicate that multiple users (e.g. user 111 and user 115) can view the same AR or VR content, at the same time, or at different times, using the same overall system.

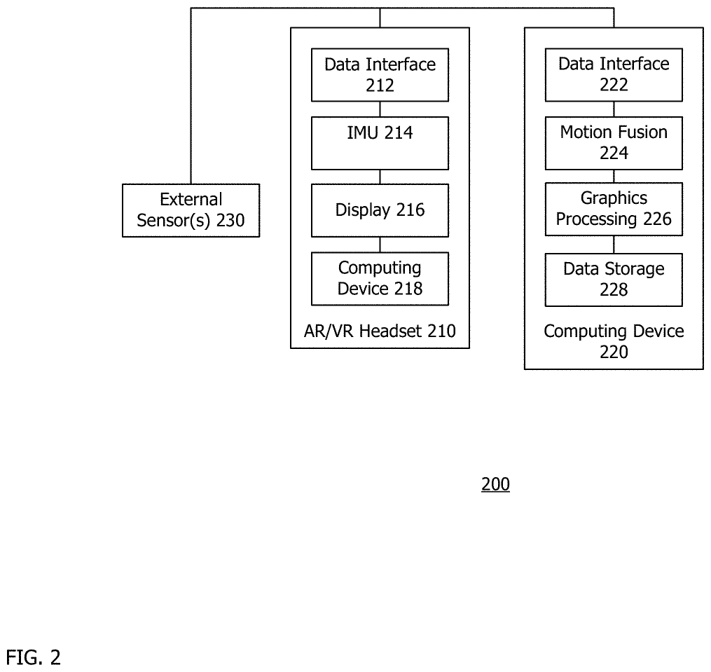

The computing device 120 is a computing device (FIG. 2) that is connected to the AR/VR headset 110 and AR/VR headset 114 via the network. The computing device 120 may offer its computational capabilities to the headsets 110, 114 for, for example, rendering the three-dimensional scene or object(s) and for performing sensor fusion (i.e., the integration of tracker and motion sensor data to continuously update the position of the headsets 110, 114). The computing device 120 may also offer a place to store art assets and models used by the headsets 110, 114 or to store previously recorded movements and highlights from a particular traversal through a three-dimensional model or environment.

As used herein, the phrase “three-dimensional model” means a three-dimensional object, rendered in virtual or augmented reality, or a three-dimensional environment rendered in virtual or augmented reality. The three-dimensional model may be stand-alone, so that it fills effectively the entire vision of a viewer or the entirety of an available display, or it may be augmented reality wherein one or more three-dimensional objects are superimposed over a real-time view of a physical space recreated using an external facing camera or set of cameras.

The network 150 is a system for passing data between the AR/VR headsets 111, 114 and the computing device 120. The network may be or include the Internet, as well as various systems such as Bluetooth®, Ethernet, 802.11x wireless networking, short-range RF frequency wireless networking systems, and other network types capable of passing data between the other components of the system 100.

FIG. 2 is a functional block diagram of a system 200 for interacting with three-dimensional objects in augmented reality or virtual reality. The system 200 includes an AR/VR headset 210 and a computing device 220 as well as optional external sensor(s) 230. For purposes of discussion here, a second AR/VR headset is not shown, though many could be present. Each would have functions similar to those shown for AR/VR headset 210.

The AR/VR headset 210 includes a data interface 212, an inertial measurement unit (IMU) 214, a display 216, and may include a computing device 218. These components are described functionally, because it aids in understanding of the overall system, but they may be implemented in one or more physical systems or components.

The data interface 212 is used to exchange data between the AR/VR headset 210, the computing device 220, the external sensor(s) 230, and any other AR/VR headset or display that may be used to view the same three-dimensional model or models as the AR/VR headset 210. The data interface 212 may be or include the Internet or Internet access and may rely upon various physical and logical systems or protocols such as those described above.

The inertial measurement unit (IMU) 214 is an integrated system-on-a-chip that typically incorporates a series of sensors for motion and position tracking within space. The capabilities vary for these inertial measurement units from basic IMUs that incorporate only gyroscopes, to more complex ones that incorporate barometers, multiple gyroscopes, altimeters, magnetometers, and include capabilities of integrating visually-generated data (e.g. infrared or RGB camera data) to track the movement of a device into which they are integrated. The output from IMU 214 may be a raw estimate of the change in position and orientation between its last update and the present update given as a quaternion. The IMU 214 may output raw data that is used by other computing capabilities to perform sensor fusion wherein an independent measure of motion and/or current position and orientation are provided. Preferably, the IMU 214 itself performs this function, but it may be offloaded in whole or in part to the computing device 218 or to motion fusion 224 (on the computing device 220). Though shown as an IMU 214, an IMU may be functionally created using one or more independent sensors and associated programming implemented by the computing device 218, without actually being an IMU. The resulting output may be the same as if it were an IMU.

The display 216 is a system for showing the three-dimensional model to a wearer of the AR/VR headset 210. The display 216 is preferably an integrated display, waveguide, or micro-projector that presents the image to the eyes of a wearer of the AR/VR headset 210. However, as discussed above, the display 216 may be external, and the user's head may be tracked only to enable interaction with that external screen. The display 216 is shown as a single display, but may be multiple displays or projectors. An external display may be provided so that viewers without access to the AR/VR headset 210 may view the content as it is being viewed by the wearer.

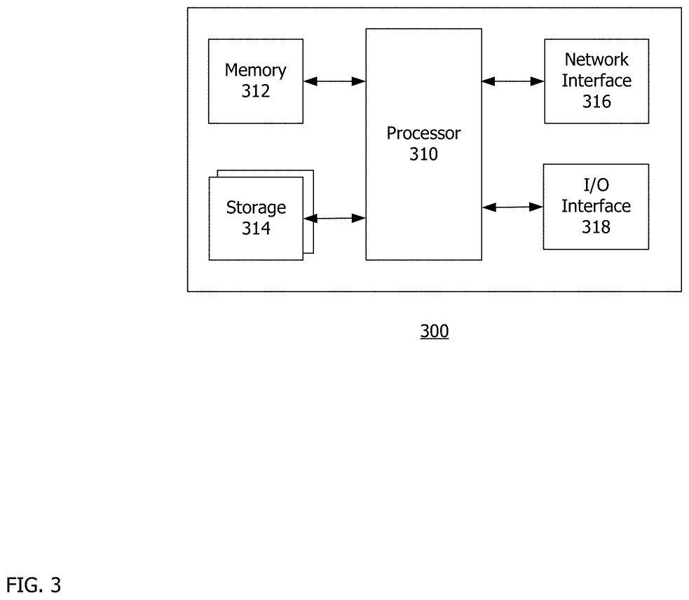

The computing device 218 may be a general purpose computing device (e.g. FIG. 3) or may be a specialized computing device with an integrated IMU 214, graphics processing capabilities, and general purpose processing capabilities integrated into a single system-on-a-chip. More commonly, AR/VR headsets are integrating such special purpose chips, but one is not required. The computing device 218 may perform the entire process of integrating sensor data from the IMU 214 and any external sensor(s) 230, gathering relevant three-dimensional model data, integrating any data about the environment in which the system is operating (e.g. the exterior physical world), the textures for the three-dimensional model, and generating a three-dimensional model for display on the display 216. The computing device 218 may, instead, offload much of that to external capabilities, and only be responsible for directing the display of data provided to the computing device 218, and transmitting data, using the data interface 212, generated by the IMU 214.

The external sensor(s) 230 may aid in generating motion data for the IMU 214 and/or the motion fusion 224. The external sensor(s) 230 are external in the sense that they are separate from the AR/VR headset 210 and the computing device 220, but they may take many forms. The external sensor(s) 230 may be or include traditional RGB cameras, infrared cameras, depth sensors, light-emitters and corresponding light detectors, infrared lights that are detected by other cameras on the AR/VR headset 210, or other, similar sensors and tracker systems. Data from the external sensor(s) 230 may track the head and/or eyes of a user of the system 200, or may track the physical world itself to provide that data to the AR/VR headset 210 and/or the computing device 220 for inclusion of that tracking data in eventual representation of one or more three-dimensional models to a user using the AR/VR headset 210.

The computing device 220 includes a data interface 222, motion fusion 224, graphics processing 226, and data storage 228. These components are described functionally, because it aids in understanding of the overall system, but they may be implemented in one or more physical systems or components. The computing device 220 may be a server, physically near or remote from the AR/VR headset 210 which may be implemented as a cloud-based compute system. The computing device 220 may be integrated into the AR/VR headset 210 (e.g. as computing device 218), but may be distinct from it, and connected by a high-speed data transmission including wired or wireless communications.

The data interface 222 is used to exchange data between the AR/VR headset 210 and the computing device 220 and the external sensor(s) 230 and any other AR/VR headset or display that may be used to view the same three-dimensional model or models as the AR/VR headset 210. The data interface 222 may be or include the Internet or Internet access and may rely upon various physical and logical systems or protocols such as those described above.

The motion fusion 224 is or includes a specialized processor for processing motion-based and location-based data, and operating on data representative of three-dimensional spaces and objects. Alternatively, the motion fusion 224 is or includes a general purpose processor specially programmed to operate on motion-based and location-based data, and operating on data representative of three-dimensional spaces and objects. The motion fusion 224 may be the component on the computing device 220 that receives motion and location data from the IMU 214 and any external sensor(s) 230 and generates data indicative of ongoing movement of and location of the AR/VR headset 210. This data may be used to generate augmented reality or virtual reality environments, including three-dimensional models for display on the display 216.

The graphics processing 226 is or includes a specialized processor for generating three-dimensional environments on a display. The graphics processing 226 may be or include a GPU (graphics processing unit). The graphics processing 226 is used to generate the three-dimensional graphics that are representative of the three-dimensional model for display on the display. That model may be augmented reality (e.g. to be superimposed over an image of the physical location) or virtual reality (entirely computer generated).

The data storage 228 is storage for user information, graphics textures, three-dimensional models, login information, or other data used to access and generate the three-dimensional models using the computing device 220. The data storage 228 may also act as a long-term repository for data that may be accessed by the AR/VR headset 210 or other AR/VR headsets as they seek to view the three-dimensional models.

The data storage 228 may also store traversals, or series of actions or movements made by a given viewer using an AR/VR headset 210 or highlights identified by a given viewer so that the same traversal or highlights may be seen by subsequent viewers or simultaneous (or substantially simultaneous) viewers. In this way, the model may be viewed by many and any particular points of interest or locations of interest may be preserved, and viewed and understood by others, both local to the originating AR/VR headset 210 and in locations that may be far removed. Data for those traversals and highlights may be also be stored by data storage 228.

Turning now to FIG. 3, a block diagram of a computing device 300 is shown. The computing device 300 may be representative of the server computers, client devices, mobile devices and other computing devices discussed herein. The computing device 300 may include software and/or hardware for providing functionality and features described herein. The computing device 300 may therefore include one or more of: logic arrays, memories, analog circuits, digital circuits, software, firmware and processors. The hardware and firmware components of the computing device 300 may include various specialized units, circuits, software and interfaces for providing the functionality and features described herein.

The computing device 300 may have a processor 310 coupled to a memory 312, storage 314, a network interface 316 and an I/O interface 318. The processor 310 may be or include one or more microprocessors and application specific integrated circuits (ASICs).

The memory 312 may be or include RAM, ROM, DRAM, SRAM and MRAM, and may include firmware, such as static data or fixed instructions, BIOS, system functions, configuration data, and other routines used during the operation of the computing device 300 and processor 310. The memory 312 also provides a storage area for data and instructions associated with applications and data handled by the processor 310. As used herein, the word memory specifically excludes transitory medium such as signals and propagating waveforms.

The storage 314 may provide non-volatile, bulk or long-term storage of data or instructions in the computing device 300. The storage 314 may take the form of a disk, tape, CD, DVD, SSD, or other reasonably high capacity addressable or serial storage medium. Multiple storage devices may be provided or available to the computing device 300. Some of these storage devices may be external to the computing device 300, such as network storage or cloud-based storage. As used herein, the word storage specifically excludes transitory medium such as signals and propagating waveforms.

The network interface 316 is responsible for communications with external devices using wired and wireless connections reliant upon protocols such as 802.11x, Bluetooth®, Ethernet, satellite communications, and other protocols. The network interface 316 may be or include the internet.

The I/O interface 318 may be or include one or more busses or interfaces for communicating with computer peripherals such as mice, keyboards, cameras, displays, microphones, and the like.

### Description of Processes

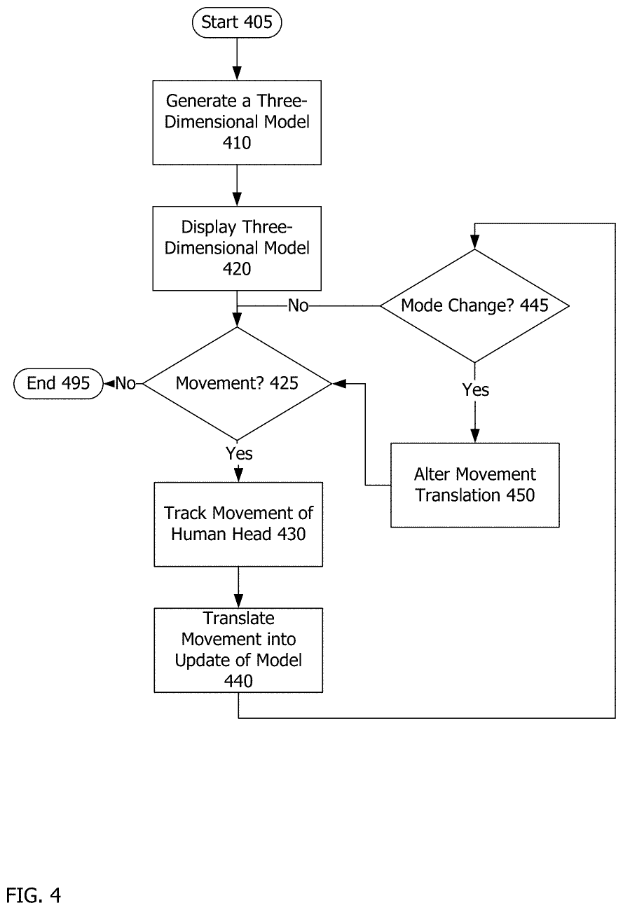

FIG. 4 is a flowchart of a process for interacting with three-dimensional objects in augmented reality or virtual reality. The flowchart has a start 405 and an end 495, but the overall process may take place many times over in rapid succession or simultaneously for multiple AR/VR headsets.

Following the start 405, the process begins with generation of a three-dimensional model at 410. As indicated above, this may be an entire environment (e.g. a virtual reality) or may be only some overlay or overlays within an image of reality (e.g. augmented reality). Either or both may take into account the physical space in which the three-dimensional model is being generated. For example, in augmented reality, the three-dimensional model may be an automobile design in three dimensions for review by a group of engineers. The size and position of the automobile design may take into account the location and size of the location where it is being presented (e.g. it may hover over a conference room table and be sized to fit within the relevant space). Alternatively, the three-dimensional model may be completely untethered to either location or space. Preferably, at least as an initial state in either AR or VR, the model will be fixed relative to the physical world such that movements relative to the physical world will result in corresponding movements relative to the three-dimensional model. For example, if an engineer wearing an augmented reality headset moves around the conference room table over which the model is hovering, the engineer will likewise move around the automobile (e.g. from front, to side, to back).

The generation of the three-dimensional model at 410 may rely upon capabilities of the AR/VR headset 210 of FIG. 2 and/or the capabilities of the computing device 220. There may be textures and the model itself may derived from data in data storage 228. Sensors on the headset and external to the headset may be used to generate data that is used in creating the three-dimensional models at 410.

Thereafter, the three-dimensional model is displayed at 420. This display will be on the display (e.g. display 214). As discussed above, this will preferably be a display integrated into the AR/VR headset 210. However, it may be a display, projector, or waveguide or other display system external to the AR/VR headset. Whatever the method that is used to display the three-dimensional model, it is displayed at step 420.

For reference, an automobile design is discussed above, but the three-dimensional model may take many forms. A fully-rendered three-dimensional model of an active mining operation may be the three-dimensional model. Such a model may include active mines, test mines, drilled cores or samples from potential mining locations, and even active equipment may be included in such a three-dimensional model. Such a model may be highly feature accurate. For example, it may incorporate actual data for miles covering an active mining operation, and data may be accurate to the foot or half-foot, so that contours, test mines, and the like may be visible in the model at extreme levels of zoom, but may be hidden from view in large, overviews of the location.

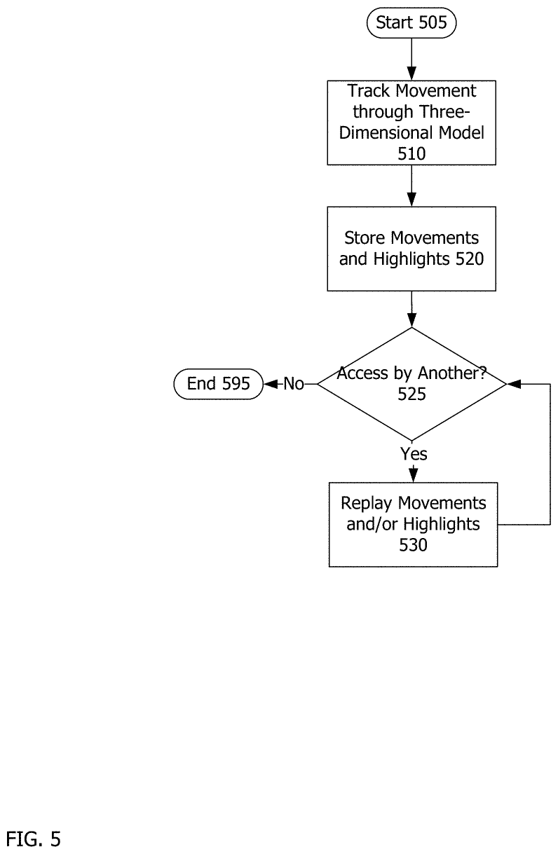

The model may be based upon recent or even same-day images captured by drone, by LIDAR imaging, or other systems that are fully rendered in three-dimensions. Models like this enable better mine planning and operational objectives. The capability to view them, in a group at locations that may be far remote from the mine itself, offers logistical advantages over requiring all viewers to be present physically at the site. In addition, as discussed more fully with reference to FIG. 5 below, allowing one viewer to store a traversal and highlights of a given model enable a “guided tour” of the three-dimensional model that may be viewed by others later for planning or other purposes.

Other three-dimensional models are possible such as aircraft or ship designs, highway system designs, detailed computer chip designs or mask works including millions of individual transistors and other components, home or business construction sites or building layouts, a large distance (e.g. hundreds of miles) pipeline system for water or petroleum products, concert or outdoor event venues, and various other models may be made visible at these steps. It is important to note that these models may be designed in such a way that they may be seen from a great “distance” artificially (e.g. miles of distance may be translated to inches on the display), but that they can include significant detail such that individual concertgoers at a concert or individual transistors for a computer chip may be visible within the same three-dimensional model with sufficient levels of zoom applied to the model.

In such a context, it can be incredibly difficult to point out to a remote (or even local) participant a particular location, component (e.g. transistor) or test mine. Some way of identifying or highlighting a particular component or location is valuable. In that way, subsequent viewers of the same model or even simultaneous viewers who may not be present in the same physical location may view the same three-dimensional model and be made aware of a particular location within the model.

Turning next to step 425, a determination is made whether there is movement of the user's head. This may be an IMU in the head-mounted display as discussed above, and/or through the use of external trackers such as cameras and infrared sensors to detect movement of the user's head.

If movement is detected (“yes” at 425), then that movement is tracked at 430. That tracking may track the general direction of the movement, e.g. forward or back, relative to the model, turning of the head from side-to-side, relative to the model, or tilting of the head up or down, relative to the model. In addition, it may track the head within the physical space.

Whatever that movement is, it is translated into movement of the model such that the model is updated at 440. In making this translation, a determination may be made as a mode of translation (of at least two, potentially many) for the model is being used. For example, if in a first mode, the translation may operate much as discussed above with respect to three-dimensional video games such that movement forward moves the model closer to the viewer, and movement backward moves the model away by an amount determined by the distance moved by the viewer. Movement to the side leaves the model fixed relative to the physical world and causes the viewer to move “around” or relative to that model such that a different perspective is seen, but the model appears to be fixed in that physical world (in the case of an augmented reality model). Tilting of the head up or down causes a perspective shift such that portions of the model above or below may be seen, if they were not visible before, otherwise the model appears to remain fixed in the physical world.

This movement and translation may go on for some time in a given mode from 425 to 440 without any change. If there is no movement (“no” at 425), then the process may end at 495.

Next, a determination is made whether there has been a mode change at 445. This mode change may involve flipping a physical switch, touching a button, and/or using a controller to press a button or analog stick. The mode change may alternatively involve a gesture (e.g., a hand gesture), such as mimicking tapping an object, tapping a finger and thumb together, a snap, or simply making a hand gesture (e.g. two finger's raised) and moving a hand from left to right. It may be a voice command, looking in a certain direction within an AR/VR headset, or utilizing an in-AR or in-VR menu system to select a mode change. Numerous activities could trigger a mode change, but regardless a mode change may be made by a user.

Assuming there was a mode change (“yes” at 445), then thereafter, the translation may be altered at 450, such that the same types of motion may result in very different interactions with the three-dimensional model. For example, after the mode change from the first mode to a second mode, movements toward and away from the three-dimensional model could result in “zooming in” and “zooming out” relative to the model. In such a case, the model may remain fixed relative to, for example, a center point or a center point determined by a user's vision (e.g. a center point of the AR/VR display), but may, rather than cause the model to move relative to the user's movement, cause the model to grow larger as a user moves toward it or grow smaller as a user moves away from it. Such a “zoom” capability may enable viewing of details not visible in a large-scale viewing of an overall model that then become visible upon a closer “zoom” of that same model. The zoom may be fixed, e.g. a direct translation from one movement to the other (e.g. one foot forward equals 100× zoom of the model) or may be a continuous system such that stepping one foot forward causes a zoom process to begin until the user returns to an original position, thereby stopping the zoom. Stepping back, likewise, could begin a de-zoom process, while stepping back to an original position could end such a de-zoom process.

Likewise, in a second mode, turning one's head from side to side may cause the model to rotate, rather than simply providing more or a different perspective of the same model. Tilting one's head up and down, relative to the model, may cause the model to rotate down and toward a user or up and away from a user. These two rotation systems may enable accurately targeting or viewing a particular portion of the model, particularly when coupled with the zoom function of moving toward the model. For example in a first mode, if the user were to rotate the user's head, an object might move out of the user's field of vision in the opposite direction of that rotation. However, in a second mode, when the user turns the user's head, the object may stay in the same place in the user's field of vision, but will rotate in place. Further, the zoom may be centered around the center of the object or may be centered on a center of vision of the wearer of the AR/VR headset.

Thereafter all movement (“yes” at 425) may be translated according to that new mode until the process ends with no movement (“no” at 425) or a second mode change (“yes” at 445) occurs to cause the mode to change to a different mode. The process may end at 495 when motion stops.

Though discussed purely with respect to the user's head, the user's hands may also be tracked or may be tracked instead, for example, using hand-worn gloves or infrared lights or an external tracker or camera. The hands may be used in much the same way as the user's head. When operating in a first mode, movement of one or both hands in one direction may result in one movement translation, but when in a second mode, the same movement of one or both hands may be translated in a different way. For example, movement of the hands toward or away from the model may cause the model to appear to move closer or further away from a user in one mode, but in another mode may cause the model to become larger or smaller (e.g. zoom in or out) including greater or lesser detail as a result. Likewise tilt to one side or the other side may cause the model to turn, or to rotate in one mode, while making the model merely move from side to side in another.

FIG. 5 is a flowchart of a process for sharing interaction with three-dimensional objects in augmented reality or virtual reality. This process begins with start 505 and ends with end 595. Though, the process can be taking place many times simultaneously or over the course of a given time period.

Following the start 505, the process begins with tracking the movement of a given user through a three-dimensional model at 510. This tracking is distinct from that of FIG. 4 in the sense that this tracking is over a set period of time that is more than a single set of movements. This tracking is a large portion of an interaction with a three-dimensional model so that, for example, a user's overall interaction with the model may be ascertained and, in effect, played-back for a subsequent (or simultaneous) viewer.

If viewing by another is simultaneous, this tracking step at 510 may also incorporate the capability to broadcast those movements so that others in the same physical location or potentially very remote from the user being tracked may “follow along” with the viewer as he or she moves through a given model. In this way, viewers who may be distant from the leader may view the same model and see the same perspectives. This enables easier interactions and descriptions of particular portions of the model (e.g. particular transistors, sections of an active mine, or other specifics). This may be called a “traversal” of the model.

The controlling user may also introduce highlights, either flagging or tagging particular sections of the overall model for subsequent viewing or discussion. For example, a user may engage in some activity to cause a highlight to be created at his or her point of focus (e.g. a pointer visible on the display or a center of vision always present for the display. This activity may be a click of a button, touching a screen, a voice command, or other activity. That activity may also be tracked and provided to remote or local viewers of the same content.

To enable later viewing of the same traversal and any associated highlights, those movements and highlights are stored at 520. This may enable subsequent viewers, including the individual who created the traversal and highlights, to find the same component, sub-part, or detail that he or she previously found in a given traversal. The highlighting also enables users to find the same exact point so that meaningful conversations about a given highlight may be had, even while at distances remote from one another.

Thereafter, the same model may be accessed by another at 525. If so, (“yes” at 525), then the movements and highlights may be replayed at 530 as if the subsequent viewer is along for a ride with the original viewer who made the traversal and highlights. The changes of mode may be preserved. This traversal and highlights, notably, is not or is not only a “video” of the traversal and highlights. It is a re-traversal through the associated movements with reference to the model itself. In this way, a series of data points and movements may be stored that result in the same traversal, rather than a video of the traversal. Once the end is reached (or at any point along the way) the subsequent viewer may control the view so that orientation may be more clearly made. The subsequent viewer may even make revisions to the traversal or make subsequent annotations (e.g. beginning their own session at 505).

If there is no access by another (“no” at 525) or following a viewing by another and no subsequent viewers (“no at 525), then the process may end at 595.

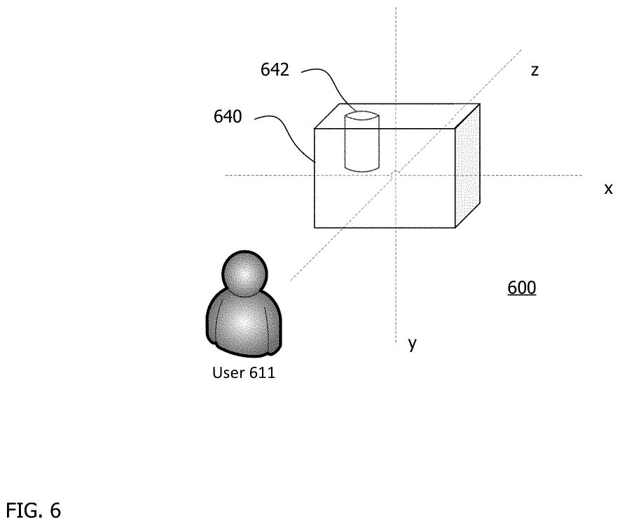

FIG. 6 is an example 600 set of three-dimensional objects making up a three-dimensional model. The example 600 is intentionally simple for ease of understanding. Preferably, the three-dimensional model will be sufficiently complex that viewing its details requires somewhat complex movements and zooming into the model 640. Here, the model includes an (x, y, z) axis because it has width, height, and depth. For purposes of this example, it includes a single detail 642, which is a cutout section which could be representative of a test mine in a large-scale mining operation. If that example were accurate, this would be only a tiny subset of an overall three-dimensional model that is currently being viewed by user 611.

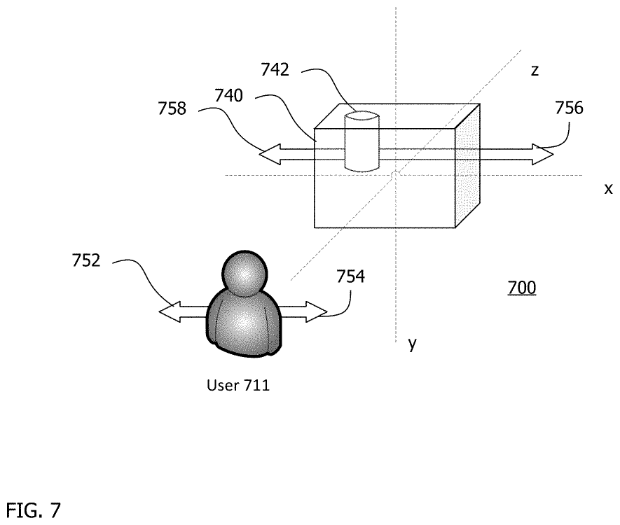

FIG. 7 shows an interaction with an example set 700 of three-dimensional objects in a first mode. Here, a user 711 moves from left 752 to right 754. The object 740 and detail 742 remain fixed, relative to the physical world, but much like the physical world, as a user moves to his or her right 754, the object appears, in a sense, to move to his or her left 758 because the user can now see more of the “right side” of that object. Likewise, as the user moves to his or her left 752, the object appears to move relative to the physical world, to his or her right 756 because more of the left side of the object is visible to the user 711.

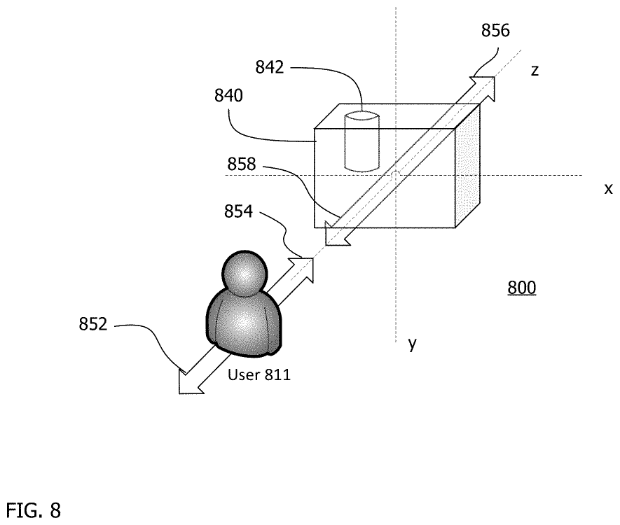

FIG. 8 shows a different interaction with an example set 800 of three-dimensional objects in a first mode. Here, the user 811 is moving forward 854 and backward 852, relative to the object 840 and the detail 842. In the first mode, the object remains fixed relative to the physical world, but to the user as he or she moves forward (closer) 854, the object appears to move closer 858 because the object is fixed relative to the physical world. As the user moves backward 852, the object appears to retreat 856, again because it is fixed relative to the physical world.

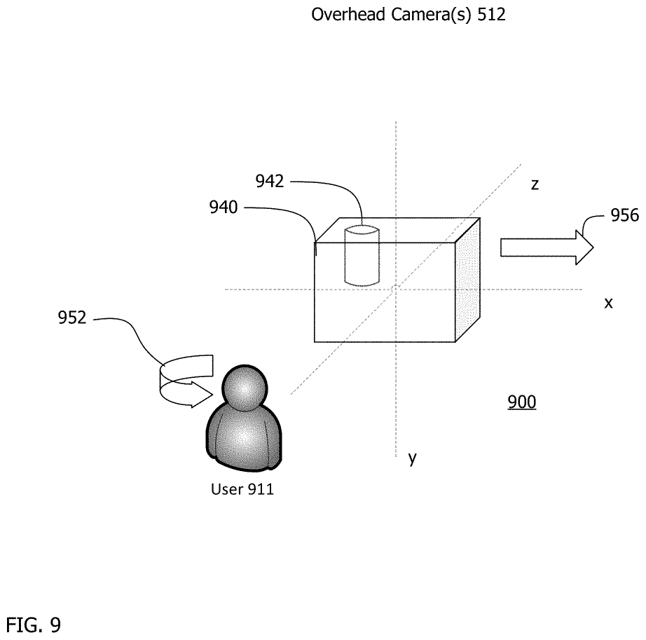

FIG. 9 shows still another interaction with an example set 900 of three-dimensional objects in a first mode. Here, the user 911 is turning his or her head from side-to-side. Here, the user 911 is rotating his or her head from right to left 952. This results in the object 940 and detail 942, which are fixed relative to the physical world, to appear to shift to the right 956 (out of the area of vision of the user 911). Less of the object 940 are visible in the vision of the user 911 because he or she has turned his or her head and the object 940 has remained fixed relative to the physical world.

The same general interaction would result in tilting ones' head from up to down.

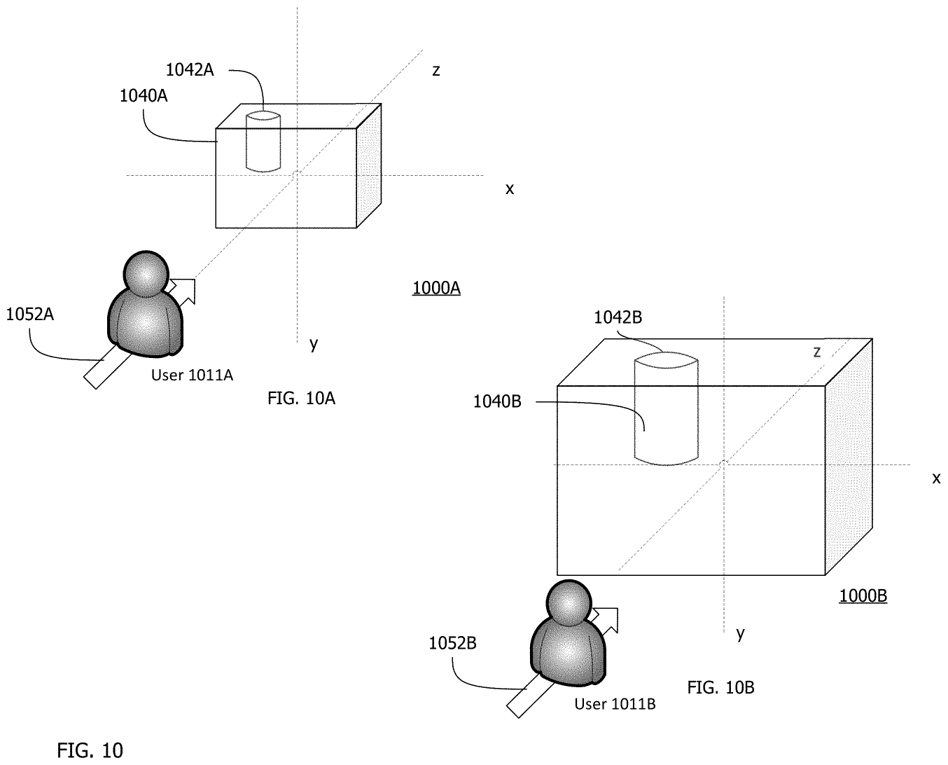

FIG. 10, including FIGS. 10A and 10B, shows an interaction with an example set of three-dimensional objects in a second mode. Here, in a second mode, the user 1011A moves forward 1052A toward the object 1040A and detail 1042A in set 1000A at time t=0. At time t=1, forward 1052B movement of user 1011B has caused the object 1040B and detail 1042B to appear to grow larger, relative to the physical space in set 1000B. This is because in the second mode, the movement is being translated differently, in this case, as a “zoom” function. The opposite would be true in a backward motion causing “zoom out” relative to the object. As indicated above, the zoom may be centered around the center of the object or may be centered on a center of vision of the wearer of the AR/VR headset.

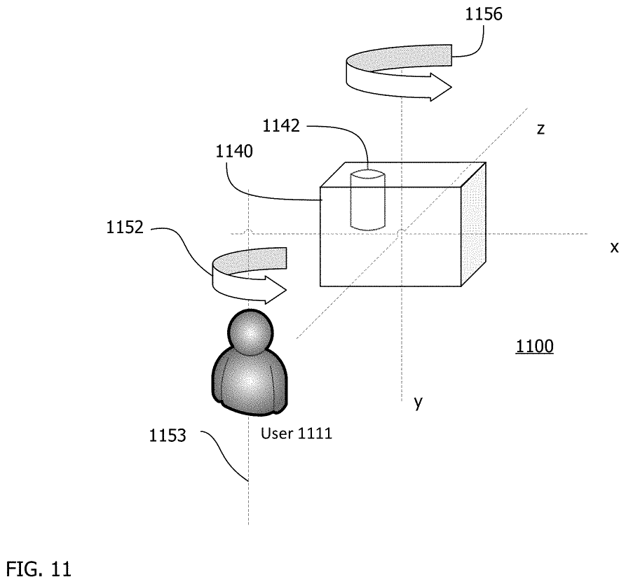

FIG. 11 shows a different interaction with an example set 1100 of three-dimensional objects in a second mode. Here, the user 1111 is turning 1152 his or her head from right to left along an axis 1153. The object 1140 and detail 1142 likewise rotate 1156, in this second mode, about a perpendicular axis (y, in this case) in a manner corresponding to the rotation of the user 1111 head. This corresponding manner may not be a direct translation such that small rotation may cause a much larger rotation of the object 1140.

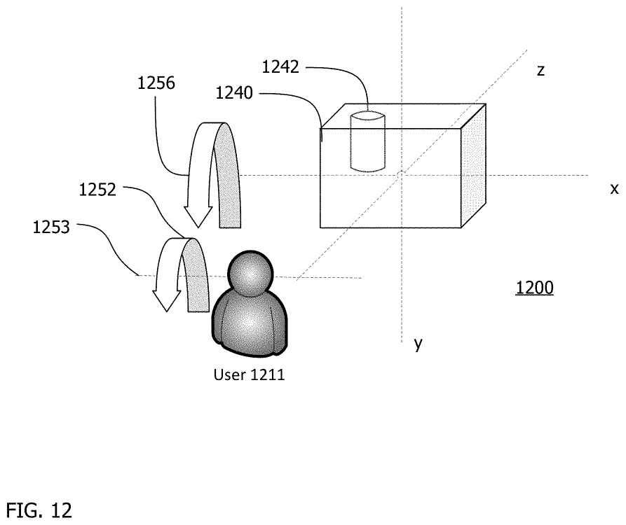

FIG. 12 shows still another interaction with an example set 1200 of three-dimensional objects in a second mode. Here, the user 1211 is tilting 1252 his or her head upward along an axis 1253. The object 1240 and detail 1242 likewise tilt 1256, in this second mode, along a perpendicular axis (x, in this case) in a manner corresponding to the rotation of the user 1211 head. This corresponding manner may not be a direct translation such that small rotation may cause a much larger rotation of the object 1240. In this second mode, the object may remain fixed in a position relative to the physical world, but rotate within that space in a manner corresponding to the tilt of the user's head.

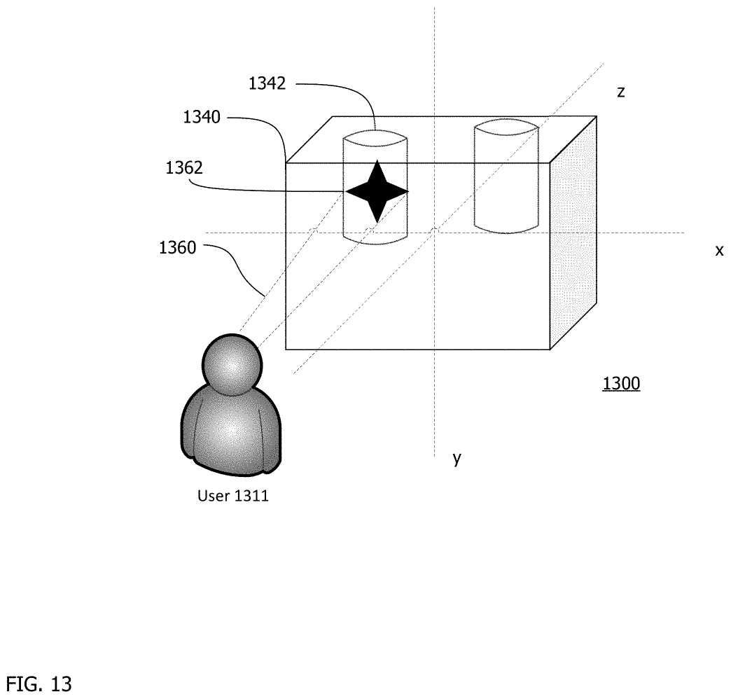

FIG. 13 shows a user creating a sharable interaction including a user highlight 1362 with an example set 1300 of three-dimensional objects. Here, the original user's gaze may have been used to create a highlight (or many) 1362 during a traversal through a three-dimensional model, resulting in a detailed viewing of the object 1340 and this detail 1342. The user 1311 may have desired to point out this particular detail 1342 to his or her compatriots operating upon the same model from a remote location. This second viewer, user may now traverse that same process to view the overall model, arriving at the set 1300 of three-dimensional objects to now see this highlight 1362 on the detail 1342 and now may be aware that this particular detail 1342 is the one that the original user wished the current user to see within the vast scale of the overall model.

### Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A system for interacting with a computer-generated three-dimensional model, the system comprising:
a head-mounted display for displaying the three-dimensional model, the head-mounted display incorporating at least one sensor for tracking movement of a human head, the head-mounted display in communication with a computing device used in generating the three-dimensional model, the computing device further for:
translating the movement tracked by the at least one sensor into a first set of actions, relative to the three-dimensional model, when in a first mode; and
upon an indication by a user, changing to a second mode and translating the movement tracked by the at least one sensor into a second set of actions relative to the three-dimensional model.

2. The system of claim 1 wherein, in the first mode:
the movement is tracked such that a position of the three-dimensional model remains fixed, relative to a physical world; and
the movement of the human head when in the first mode is translated into movement relative to the three-dimensional model fixed within the physical world.

3. The system of claim 2 wherein, in the first mode, the movement is translated as follows:
forward or backward movement, relative to the three-dimensional model, causes the three-dimensional model to be shown from a closer or further away perspective, but otherwise remains unchanged;
tilt of the human head upward or downward, relative to an orientation of the three-dimensional model, causes a perspective of the three-dimensional model to update such that portions of the three-dimensional model that were outside of a view of the user come within view; and
rotation of the human head along a vertical axis causes a perspective of the three-dimensional model to update such that portions of the three-dimensional model that were outside of a view of the user come within view along a corresponding vertical axis.

4. The system of claim 1 wherein, in the second mode, the movement is tracked such that a position of the three-dimensional model remains fixed, relative to the user and:
the movement of the human head when in the second mode is translated into movement of the three-dimensional model relative to the user head.

5. The system of claim 4 wherein, in the second mode, the movement is translated as follows:
forward movement causes the three-dimensional model to increase in size and detail, relative to a time prior to the forward movement; and
backward movement causes the three-dimensional model to decrease in size and detail relative to a time prior to the backward movement.

6. The system of claim 4 wherein, in the second mode, the movement is translated as follows:
tilt of the human head upward or downward, relative to an orientation of the three-dimensional model, causes the three-dimensional model to rotate about an axis perpendicular to a gaze of the human head.

7. The system of claim 4 wherein, in the second mode, the movement is translated as follows:
rotation of the human head along a vertical axis causes corresponding rotation of the three-dimensional model about a parallel axis running through the three-dimensional model.

8. An apparatus comprising non-volatile machine-readable medium storing a program having instructions which when executed by a processor will cause the processor to generate a three-dimensional model for display on a head-mounted display;
display the three-dimensional model on the head-mounted display;
track movement of a human head using at least one sensor:
translate the movement tracked by the at least one sensor into a first set of actions, relative to the three-dimensional model, when in a first mode; and
upon an indication by a user, change to a second mode and translate the movement tracked by the at least one sensor into a second set of actions relative to the three-dimensional model.

9. The apparatus of claim 8 wherein, in the first mode:
the movement is tracked such that a position of the three-dimensional model remains fixed, relative to a physical world; and
the movement of the human head when in the first mode is translated into movement relative to the three-dimensional model fixed within the physical world.

10. The apparatus of claim 9 wherein, in the first mode, the movement is translated as follows:
forward or backward movement, relative to the three-dimensional model causes the three-dimensional model to be shown from a closer or further away perspective, but otherwise remains unchanged;
tilt of the human head upward or downward, relative to an orientation of the three-dimensional model, causes a perspective of the three-dimensional model to update such that portions of the three-dimensional model that were outside of a view of the user come within view; and
rotation of the human head along a vertical axis causes a perspective of the three-dimensional model to update such that portions of the three-dimensional model that were outside of a view of the user come within view along a corresponding vertical axis.

11. The apparatus of claim 8 wherein, in the second mode, the movement is tracked such that a position of the three-dimensional model remains fixed, relative to the user and:
the movement of the human head when in the second mode is translated into movement of the three-dimensional model relative to the user head.

12. The apparatus of claim 8 wherein, in the second mode, the movement is translated as follows:
forward movement causes the three-dimensional model to increase in size and detail, relative to a time prior to the forward movement; and
backward movement causes the three-dimensional model to decrease in size and detail relative to a time prior to the backward movement.

13. The apparatus of claim 8 wherein, in the second mode, the movement is translated as follows:
tilt of the human head upward or downward, relative to an orientation of the three-dimensional model, causes the three-dimensional model to rotate about an axis perpendicular to a gaze of the human head.

14. The apparatus of claim 8 wherein, in the second mode, the movement is translated as follows:
rotation of the human head along a vertical axis causes corresponding rotation of the three-dimensional model about a parallel axis running through the three-dimensional model.

15. The apparatus of claim 8 further comprising:
the head-mounted display;
the processor;
a memory;
wherein the processor and the memory comprise circuits and software for performing the instructions on the storage medium.

16. A method for interacting with a computer-generated three-dimensional model comprising:
generating a three-dimensional model for display on a head-mounted display;
displaying the three-dimensional model on the head-mounted display;
tracking movement of a human head using at least one sensor:
translating the movement tracked by the at least one sensor into a first set of actions, relative to the three-dimensional model, when in a first mode; and
upon an indication by a user, changing to a second mode and translating the movement tracked by the at least one sensor into a second set of actions relative to the three-dimensional model.

17. The method of claim 16 wherein, in the second mode, the movement is tracked such that a position of the three-dimensional model remains fixed, relative to the user and:
the movement of the human head when in the second mode is translated into movement of the three-dimensional model relative to the user head.

18. The method of claim 16 wherein, in the second mode, the movement is translated as follows:
forward movement causes the three-dimensional model to increase in size and detail, relative to a time prior to the forward movement; and
backward movement causes the three-dimensional model to decrease in size and detail relative to a time prior to the backward movement.

19. The method of claim 16 wherein, in the second mode, the movement is translated as follows:
tilt of the human head upward or downward, relative to an orientation of the three-dimensional model, causes the three-dimensional model to rotate about an axis perpendicular to a gaze of the human head.

20. The method of claim 16 wherein, in the second mode, the movement is translated as follows:
rotation of the human head along a vertical axis causes corresponding rotation of the three-dimensional model about a parallel axis running through the three-dimensional model.
